(19) United States
(12) Patent Application Publication
(10) Pub. No.: US 2026/0267614 A1
(43) Pub. Date: Sep. 10, 2026

(54) METHOD AND APPARATUS FOR API EXTRACTOR

(71) Applicant: NightVision Security, Inc., Bradenton, FL (US)

(72) Inventors: Jonathan Michael STAVIS, Cohasset, MA (US); Parsia HAKIMIAN, Burnaby (CA); Kinnaird MCQUADE, III, Lahaina, HI (US)

(21) Appl. No.: 19/165,559

(22) PCT Filed: Mar. 15, 2024
(86) PCT No.: PCT/US2024/020260

§ 371 Date: Sep. 15, 2025

Related U.S. Application Data
(60) Provisional application No. 63/452,307, filed on Mar. 15, 2023.

(51) Int. Cl. G06F 8/30

(52) U.S. Cl. CPC G06F 8/30

(57) ABSTRACT

A system and method of identifying paths in a target code, comprising defining output rules for a static analysis module output. Applying, by the static analysis module, a static analysis of the target code to generate a report under the output rules and captured code. Concatenating combinations of uniform resource locator (URL) paths to generate a set of identified paths. Expanding arrayed attributes and arrayed identified paths and merging function parameters having a common key. Identifying a path parameter corresponding to predetermined characters in at least one path in the set of identified paths and assigning one of a plurality of types to each identified path parameter. Detecting, in the captured code, a name change corresponding to at least one predetermined field. Identifying a query parameter in the captured code and assigning the identified query parameter as a query parameter name in response to a predetermined identified directive

### TECHNICAL FIELD

The present disclosure relates to a method and apparatus configured to receive a target source code to be analyzed; extract, via static analysis, matching data patterns from the target source code; discard unwanted extracted code; identify paths in the extracted code to generate a preliminary extraction; preprocess the data of the preliminary extraction; apply a decision tree to identify predetermined types of data in the preliminary extraction; document the identified types of data; and output the identified data in a predetermined industry standard format.

### BACKGROUND

Generally, application program interfaces, or “APIs”, are computer software code that allows two software programs to communicate with each other. APIs work by a client sending requests for information to a server and receiving a response from the server.

The use of APIs, especially representational state transfer (“REST”) APIs, has increased in recent years and the increase can be attributed to several reasons, including interoperability: APIs allow different software systems to communicate with each other, enabling data and functionality to be shared and reused; scalability: APIs enable different parts of an application to be developed independently and added or updated as needed, which makes it easier to scale the application; flexibility: APIs allow developers to build applications that can be easily integrated with a wide range of systems and services; ease of use: REST APIs are based on simple HTTP protocols and can be easily consumed by a wide range of programming languages and platforms, and microservices architecture. The trend towards breaking down monolithic applications into smaller, independent microservices has also contributed to the increased use of APIs as a way of connecting services. Overall, the increased use of APIs, especially REST APIs, reflects the trend towards a more connected, flexible, and scalable way of building and deploying applications.

API source code is to be accompanied by an API specification and API documentation to define the functionality of an API and to help developers understand how to use the API to build their own applications. The specification outlines the endpoints, input parameters, and output formats of the API, while the documentation provides additional information and code examples to assist in integration. This helps ensure consistency and predictability in the use of the API and helps minimize the potential for errors and misunderstandings. OpenAPI 3.0 is a specification for REST APIs and provides a standard way of defining REST APIs, including their functionality, endpoints, parameters, and response structures.

As with almost all software, APIs are continually, or at least periodically updated. These updates can include changes to the operations, inputs, outputs, and endpoints of the API. These updates may replace or add endpoints which can result in existing, but rarely used endpoints within the API. In addition, the resources accessed by the API may change, which changes require modifications to the API. While all these changes should be reflected in the associated API specification and API documentation, as the functionality of the code is the critical task, updating the specification and documentation is often neglected.

Therefore, the need exists for system and method for the analysis of a target source code, such as an API, and generating a specification and documentation of the source code. A further need exists for the analysis of target source code by a static analysis module, wherein the results of the analysis can be employed in a dynamic application security testing (DAST) module. A particular need exists for identifying, otherwise unused or undocumented endpoints by static analysis, wherein the endpoints can be subsequently provided to the DAST analysis.

### BRIEF SUMMARY

Generally, the present disclosure provides a method of generating an API specification for a target REST API source code, the method including applying a matching algorithm to a static analysis module to provide a modified static analysis module configured to extract data from the target REST API source code or applying an internal static analysis module and a plurality of combined decision trees (i.e., data processor(s)) to extract data from the REST API source code transformed into an abstract syntax tree (AST); defining a message field for the modified static analysis module, wherein the message field includes a plurality of added foreign separator characters; applying the modified or internal static analysis module to the target REST API source code to generate a report including the message field and an extracted source code; removing, from the report, extracted values having no assigned value; identifying paths in the extracted source code; concatenating at least a subset of the identified paths; expanding arrayed paths to generate a plurality of identical paths corresponding to each arrayed path; detecting a parameter name to generate an index of results and merging parameters having a common key to generate a processed output having merged parameters and expanded paths; identifying a path parameter in the expanded paths corresponding to predetermined characters in the identified paths; assigning one of a plurality of types to each identified path parameter; adding each identified path parameter to the identified path; extracting, in response to a query parameter in the extracted code having a new name directive, the new name and applying the new name as a query parameter name; identifying a request body parameter in the extracted source code; assigning one of a plurality of types to each identified request body parameter; and assigning the identified request body parameter as a request body parameter name in response to a further predetermined identified directive; identifying a request header parameter in the extracted source code; assigning a header name from a predefined set of names; assigning value of the request header from the extracted source code.

In one configuration, the present disclosure provides a method of identifying paths in a target code, the method including defining output rules or data processors for a static analysis module output; applying, by the static analysis module, a static analysis of the target code to generate a report under the output rules and captured code; concatenating parent and child paths (i.e., parts of uniform resource locator (“URL”) paths), if applicable, to generate a set of identified paths; expanding arrayed attributes and arrayed identified paths; merging function parameters having a common key; identifying a path parameter corresponding to predetermined characters in at least one path in the set of identified paths; assigning one of a plurality of types to each identified path parameter; adding each identified path parameter to the at least one identified path; detecting, in the captured code, a name change corresponding to at least one predetermined field, such as a change from a prior version of the target code; identifying a query parameter in the captured code; assigning the identified query parameter as a query parameter name in response to a predetermined identified directive; identifying a request body parameter in the captured code; assigning the identified request body parameter as a request parameter name in response to a predetermined identified directive; detecting, in the captured code, a name change corresponding to at least one predetermined field, such as a change from a prior version of the target code; emulating the behavior of web frameworks and operators of the target programming language for processing collected data.

A further method is provided of detecting hidden and/or undocumented paths in a target API code, the method including extracting, with a static analysis module pursuant to a matching algorithm, data target API code, the data including captured data and variables through a predefined message field and/or emulated state of program memory generated during analysis of the target web application code; processing the captured data to a predetermined format; preprocessing the captured data in the predetermined format to identify path parameters; comparing identified path parameters with captured path parameters to identify a parameter type; identifying a name change from a located identifier in the captured code; extracting, in response to a query parameter in the captured code having a new name directive, a new name and using the new name as a query parameter name; and employing the identified paths in a dynamic application security testing (DAST) module.

The present disclosure includes the further method of static analysis of an API source code, the method including applying a matching algorithm or predefined data processors in a static analysis module to the API source code to generate a report having extracted source code from the API source code in a message field, the message field including a plurality of automatically inserted non-operating system specific characters; removing, from the report, extracted values having no assigned value; identifying paths in the extracted source code; concatenating at least a subset of the identified paths; expanding arrayed paths to generate a plurality of identical paths corresponding to each arrayed path; detecting a parameter name to generate an index of results and merging parameters having a common key to generate a processed output having merged parameters and expanded paths; identifying a path parameter in the expanded paths corresponding to predetermined characters in the identified paths; assigning a type to each identified path parameter; adding each identified path parameter to the identified path; extracting, in response to a query parameter in the extracted source code having a new name directive, the new name and applying the new name as a query parameter name; identifying a request body parameter in the extracted source code; assigning a type to each identified request body parameter; and assigning the identified request body parameter as a request body parameter name in response to a further predetermined identified directive.

The present disclosure also provides a system and method for identifying and extracting endpoints from a target source code, including an API source code. The target source code to be analyzed is received by a computing device configured to extract, via static analysis, matching data patterns from the target source code, discard unwanted extracted code, identify paths in the extracted code to generate a preliminary extraction, preprocesses the data of the preliminary extraction, apply a decision tree to identify predetermined types of data in the preliminary extraction, document the identified types of data, and output the identified data in a predetermined industry standard format. It is contemplated the output identified data can be employed in a dynamic application software testing of the target source code.

### BRIEF DESCRIPTION OF THE SEVERAL VIEWS OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a schematic representation of an API extractor tool for extracting information from a target source code, such as an API source code, to generate an API specification in a predetermined format according to an exemplary embodiment of the presently disclosed subject matter.

FIG. 2 is a general flowchart of the API extractor tool with reference to the various modules of the tool according to an exemplary embodiment of the presently disclosed subject matter.

FIG. 3 is a flowchart of the API extractor tool module for extracting data about API calls with static analysis according to FIG. 2.

FIG. 4 is a flowchart of the API extractor tool module for deleting unwanted data from the results of the static analysis according to FIG. 2.

FIG. 5 is an example of the processing in the API extractor tool module according to FIG. 4.

FIG. 6 is a flowchart of the API extractor tool process for preprocessing the data from the static analysis, such as expanding arrays, concatenating paths, and merging select fields according to FIG. 2.

FIG. 7 is a flowchart of a decision tree in the API extractor tool according to FIG. 2.

FIG. 8 is a flowchart of the API extractor tool module for identifying the types of API call parameters in the results of the static analysis according to FIG. 7.

FIGS. 9A and 9B show an example of the processing in the API extractor tool of FIG. 8.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, etc. In some instances, well-known structures or operations are not shown or described in detail to avoid obscuring certain aspects of the present disclosure. Reference throughout the specification to “one embodiment,” “an embodiment,” “an exemplary embodiment,” “one configuration,” “one exemplary configuration” or the like means that a particular feature, structure, or characteristic described in connection with the embodiment is included in at least one embodiment of the present disclosure. Thus, the appearance of the phrase in “one embodiment,” “an embodiment,” “an exemplary embodiment,” “one configuration,” “one exemplary configuration,” or the like, throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

In addition to the changes to APIs as referenced above, there can be changes to the resources, or data models that also require changes to the APIs. For example, when the data model is changed or re-configured, the corresponding APIs and API specification packages must be updated to account for the data model changes. This process typically requires an exhaustive analysis of the data model changes as correlated to the API specification packages and to the use by specific applications in the application server environment. Often, such analysis is unable to properly account for items such as internal standards that must be met with respect to API specifications and enumerations that must be kept in sync with the database. As a result, the data model changes can result in problems with existing APIs. In addition, manually created API specifications need to be reviewed, in order to validate if all the standards and guidelines have been followed and documented. That is, undocumented changes, though valid, can create implementation issues. This approach makes the enforcement of standards and guidelines much more difficult and time-consuming, which often leads to a lack of compliance.

Most medium and large enterprise computing environments rely on a wide variety of application programming interfaces (APIs), such as REST APIs, to enable disparate computing systems to communicate with each other for the purposes of enabling robust software applications and functionality.

A further complication arises from the fact that there are many ways to define API routes in code. Even for a single code framework, there are multiple ways to define API routes. Usually, ways to define the API route must be individually identified, analyzed, and extracted. This process is prohibitively time consuming, expensive, and prone to error. While there are commercially available static application security testing (SAST) platforms, these generate noise and redundancies in the results which can actually exacerbate the problem of identifying API routes.

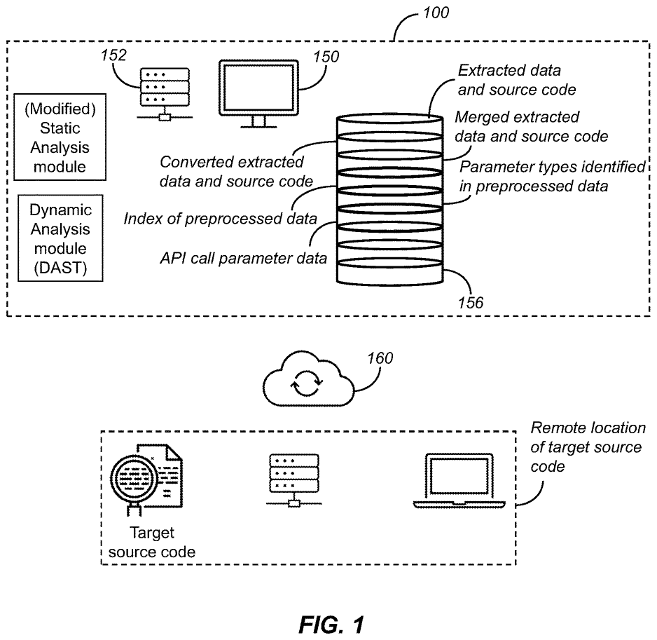

Referring now to FIG. 1, in an exemplary embodiment, an API extractor tool 100 is a program operated by a computing device 150. The computing device 150 can be a mainframe, a workstation, a desktop computer, a laptop computer, a tablet computer, a smartphone, or any electronic device capable of executing instructions, whether in firmware or in software. The computing device 150 is in communication with the Internet 160 through wireless and/or wired communications mediums. The computing device 150 includes one or more processing units (e.g., processors) 152 that are configured by instructions stored in the computing device 150 to perform the operations of the API extractor tool 100. The set of processing units 152 executing the API extractor tool 100 accesses or receives the target source code, such as target API source code 110, which can be stored at a local storage device 156 of the computing device 150, or at a remote storage over the Internet 160.

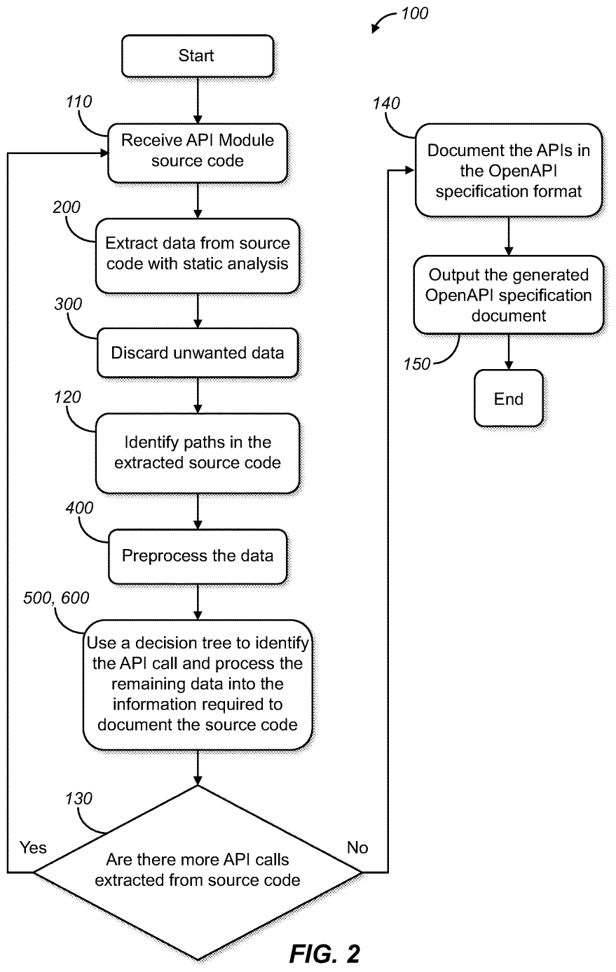

Referring now to FIGS. 2-9, flow charts of the API extractor tool 100 are shown. In one exemplary configuration, the present system receives target source code to be analyzed in step 110, extracts, via static analysis, matching data patterns from the target source code in step 200, discards unwanted extracted code in step 300, identifies paths in the extracted code to generate a preliminary extraction in step 120, preprocesses the data of the preliminary extraction in step 400, applies a decision tree to identify predetermined types of data in the preliminary extraction in step 500, 600, determines whether there are more API calls extracted from the source code in step 130, documents the identified types of data in step 140, identifies third-party dependencies that influence the formation of APIs and describing API endpoints, and outputs the identified data in a predetermined industry standard format in step 150. It is contemplated that the output identified data can be employed in a dynamic application software testing of the target source code.

In one exemplary configuration, the target source code is an API source code, and in a further configuration the target source code is a Representational State Transfer (“REST”) API.

As referenced above, an API endpoint (or endpoint) is a point at which an API connects with the software program. That is, the API endpoint is a specific digital location where requests for information are sent by one program and where the corresponding resource may be accessed. The endpoints specify where the APIs can access resources. The performance of an API at least partly depends on the ability of the API to successfully communicate with API endpoints.

API endpoints are typically defined as a unique tuple {URL, Method}. The URL represents the Uniform Resource Locator used to specify the location of a web resource on a computer network and a mechanism for retrieving it. A typical URL could have the form http://www.ibm.com/index.html, which indicates a protocol (HTTP), a hostname (www.ibm.com), and a file name (index.html). The “Method” component refers to common HTTP method requests like POST, GET, PUT, PATCH, and DELETE.

For purposes of description, an API route is a path to some website/page/controller/resource with a meaningful name to interact with the user/client. The API route receives some user input (handles user actions) and represents some results in a convenient way (for example, render markup). API routes refer to the different actions that can be performed on a particular path. For example, on the user information path, routes could include actions to create a new user, update an existing user, or delete a user.

In one configuration, the API routes, or routes, are the combination of an HTTP method and a path that determine how the API handles a specific request. For example, a GET request to “/users/:id” would be a route in the API.

Paths in an API specify the location of a resource, such as “/users/:id”. Path parameters are placeholders in the path that can take dynamic values, such as the “:id” in the above example. Parameter types define the data type of the expected value for the path parameter, such as integer or string.

Path parameters are request parameters attached to a URL that point to a specific REST API resource. The path parameter is separated from the URL by a ‘/’, and from the query parameter(s) by a question mark (‘?’). The path parameter defines the resource location, while the query parameter usually defines sort, pagination, or filter operations. The user's input (the query) is passed as a variable in the query parameter, while each path parameter must be substituted with an actual value when the client makes an API call. The path parameter is generally contained within curly braces in the source code and hence, the extracted source code.

Path parameters are part of the endpoint and are required. For example, ‘/users/{id}’, ‘{id}’ is the path parameter of the endpoint ‘/users’—it is pointing to a specific user's record. An endpoint can have path multiple parameters, like in the example ‘/organizations/{orgId}/members/{memberId}’. This would be pointing to a specific member's record within a specific organization, with both ‘{orgID}’ and ‘{memberID}’ requiring variables.

In OpenAPI 3.0, parameters are defined in the parameters section of an operation or path. To describe a parameter, a name, location (in), data type (defined by either schema or content) and other attributes, such as description (e.g., description of the parameter) or required (e.g., Boolean value) is specified. In OpenAPI 3.0, parameters are defined within the endpoint operation objects, such as “GET”, “POST”, “PUT”, etc. The parameter can also be defined at the top-level “parameters” section, and can be reused across operations. For example, there is a documented route schema for the swagger specification (e.g., API description or OpenAPI description). The documented route schema includes the address (route), the access method (HTTP method), as well as a list of parameters and other fields such as responses, comments, etc. Each parameter, in turn, has its own schema, which includes fields such as: name, type, and location in the request (e.g., body, query string, header, etc.). The parts of such schema are generally referred to as predetermined identified directives.

In OpenAPI 3.0, each parameter definition must include the following properties: name—A unique name for the parameter; in—the location of the parameter, either “query”, “header”, “path” or “cookie”; description—a description of the parameter; required—a Boolean value indicating whether the parameter is required; and schema—the data type and format of the parameter, as defined using the JSON Schema specification.

An API call is a request made by a client to access a resource through the API. The client specifies the desired resource by using the correct HTTP method (such as GET or POST) and path. The client sends a request, typically in the form of a URL or a JSON object, to a specific endpoint on the server. The server then processes the request, accesses the necessary data, and sends a response back to the client in the form of a JSON object or another data format. The response typically includes the requested data or a message indicating the outcome of the request. This process is known as an “API call” or “API request”.

An API call travels from a client to an API endpoint. As set forth below, the API endpoints are the places that an API calls go to, typically a web application and a server. A mobile client, for example, generates an API call that goes to the API endpoint, a server. The server receives the API call, processes it, executes the request, and sends a response to the client such as the mobile client.

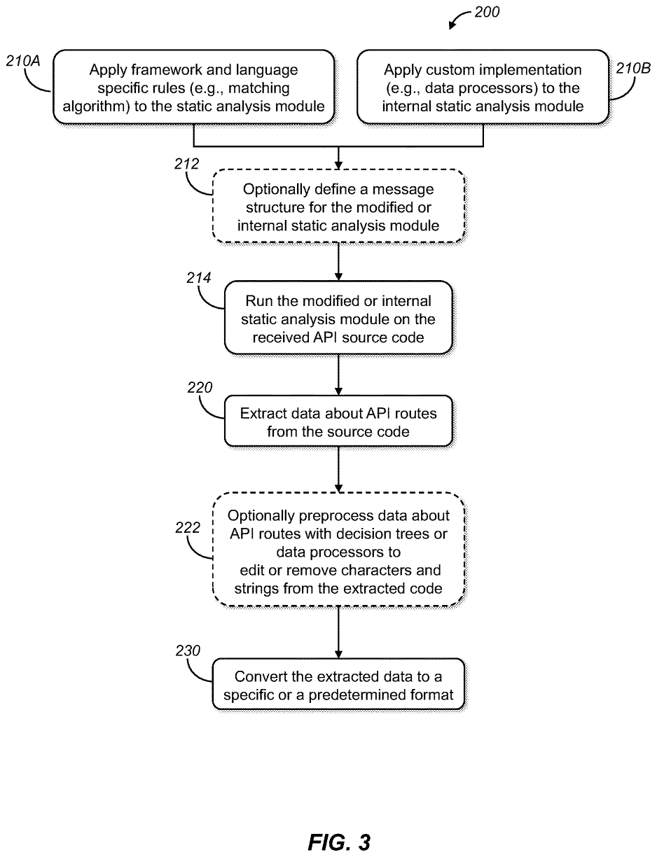

In one exemplary configuration, as illustrated in FIG. 3, the present system in step 200 applies a static analysis of the target source code, such as an API, and particularly, a REST API source code and can detect (i) undocumented/hidden API calls; (ii) hidden parameters for known API calls; (iii) outdated documentation (code is updated but the specification is not), and (iv) changes in the code (for example, new or modified routes and parameters).

The present system is configured to receive a target source code to be analyzed in step 110; extract, via static analysis, matching data patterns from the target source code in step 200; discard unwanted extracted code in step 300; identify paths in the extracted code to generate a preliminary extraction in step 120; preprocess the data of the preliminary extraction in step 400; apply a decision tree to identify predetermined types of data in the preliminary extraction in step 500, 600; document the identified types of data in step 140; apply changes to the extracted data and its combinations by processing known primitive data types such as strings, numbers, and Booleans and output the identified data in a predetermined industry standard format in step 150.

In one exemplary configuration, the API extractor 100 includes at least one custom rule for modification of a static analysis module, such as but not limited to an open source static analysis module or data processor or extension for internal static analysis module.

The static analysis module can be a static application security module (SASM) which is a security tool to identify vulnerabilities in software applications by analyzing the source code or binary code without executing the application. It is contemplated the SASM can be an automated security module that examines a code to identify security vulnerabilities such as potential backdoors, buffer overflows, SQL injection flaws, cross-site scripting (XSS) vulnerabilities, and other security-related issues. As a static analysis module, the SASM can identify these vulnerabilities before the application is deployed. The SASM typically works by analyzing the source code or binary code of an application and comparing it to a set of predefined security rules or standards. The SASM can flag any instances of code that violate these rules or standards.

Referring now to FIG. 3, in the present system, in step 200 the static analysis module is modified with at least one custom rule for the static analysis module or uses the custom implementation of the internal static analysis module extended by data processors or extensions. For example, the data processors are the extensions of the logic of the internal static analysis module. The data processors may be used as both an analog of the output rules utilized for an external static analysis module and as logical extensions of an internal static analysis module. In other words, the data processors can process the output of the internal static analysis module and extend the existing logic of the internal static analysis module. Each of the data processors includes a set of commands for processing data extracted from a particular programming language and web framework (library). In one exemplary configuration, at least one of the custom rules is configured to identify a specific pattern or a custom implementation (e.g., data processor(s)) of a static analyzer is used in step 210A or 210B. For example, the custom rule instructs the static analysis module to search for the corresponding specific pattern and extract the data associated with the specific pattern or there is a data processor for an internal static analysis module that responds to the use of a function or data type of a known framework and processes the parameters for its use in step 220. The extracted data is then converted to a specific file format, such as but not limited to JavaScript Object Notation (JSON) in step 230. An advantage of employing JSON resides in the JSON being an industry standard having numerous existing libraries. Specifically, JSON is a key/value pair format, where the target code may have components such as “key”:“value.”

In one configuration, a commercially available static analysis module, can be employed, or a custom internal static analysis module can be used, as the static analysis tool. The present system applies the rule, data processor, or matching algorithm, which configures the static analysis module in extracting corresponding data from the target source code. In one exemplary configuration, each rule has a message field that contains the information extracted from the target source code about a specific way to define the APIs in the target source code. For example, the message location in the output of the static analysis module can be predefined. Thus, the applied matching algorithm to the static analysis module provides a modified static analysis module configured to extract data of a corresponding pattern from the target REST API source code, or target API source code. In one configuration, each data processor represents a web framework or software library and emulates its behavior by processing data extracted from the source code and transforming it to produce a report.

Further, a message field or structure can be defined for the modified or internal static analysis module in optional step 212, wherein the message field includes a plurality of placeholders, such as added foreign separator characters, placeholders, or technical predefined separator symbols. For example, technical predefined separator symbols (e.g., a tilde (~)) serve to distinguish data in one message. As set forth below, while the added foreign separator characters, or placeholders, assist in the extraction, these added foreign separator characters, placeholders, or separator symbols must be subsequently removed. The separator characters, placeholders, and separator symbols are selected as being unlikely to appear in any functional code. For the internal static analysis module, a message structure can be defined by data processors and described in a way to emulate structure from web frameworks and program libraries.

Thus, the target source code, such as the target API source code is received or exposed for static analysis. The matching algorithms, data processors and framework specific rules are applied to the static analysis module, thereby providing a modified static analysis module or an internal static analysis module. The modified or internal static analysis module then runs on the target API source code in step 214. The modified static analysis module then extracts the requested data from target API source code in step 220. It is further contemplated that the extracted source code is converted to a predetermined output format, such as JSON in step 230. The internal static analysis module extracts the data and uses predefined data processors to convert it to a predetermined output format.

As the modified or internal static analysis module is applied to the target source code, a report is generated including the message field and an extracted source code in predefined format. In a specific configuration, the extraction is performed using variables through a message field of fully qualified names which describe the specific data necessary to generate the result. In addition, the extracted code and data can include characters and strings that need to be edited, removed, replaced by other values, or merged between each other, utilizing decision trees or data processors in step 222. Specifically, the extracted code is preprocessed.

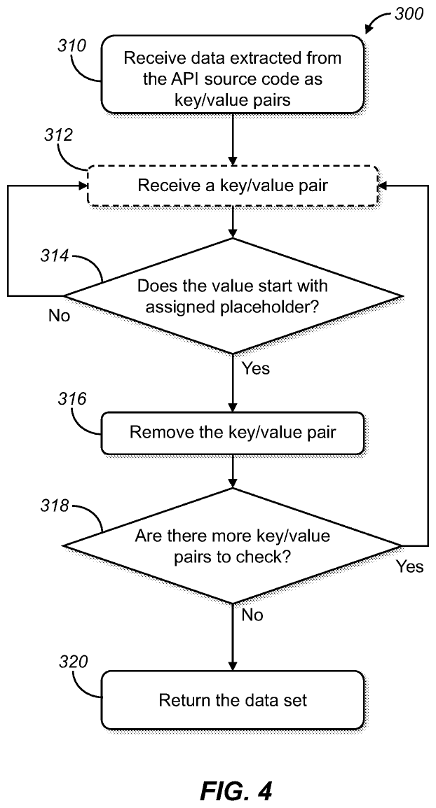

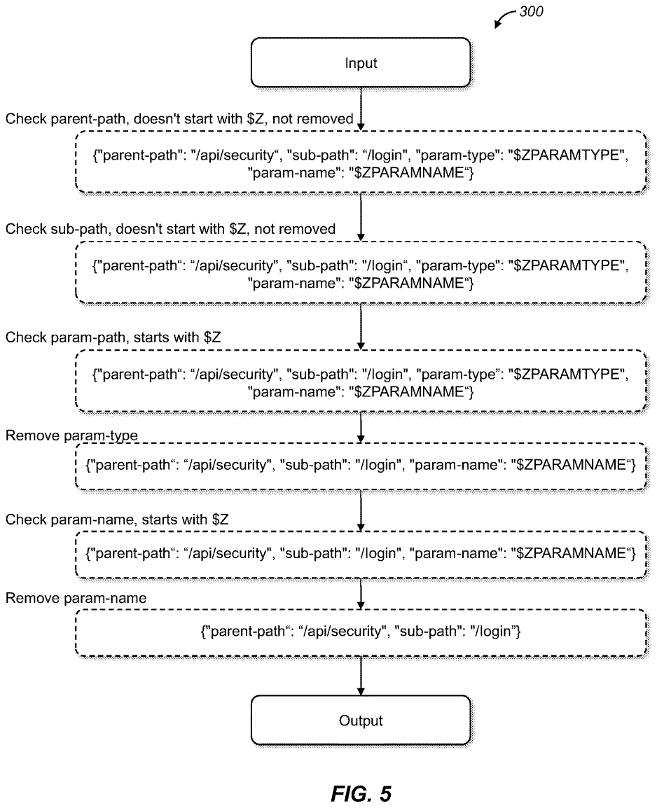

Generally, referring now to FIGS. 4 and 5, the data extracted by the modified static analysis module (the static analysis module with the applied rules (e.g., the matching algorithms)) is then analyzed to identify any empty values, wherein the empty values are automatically discarded, in step 300. In one configuration, the placeholders all start with “$Z” (as this placeholder is unlikely to otherwise appear in the source code). Thus, upon identifying a value that starts with the placeholder, the value is thus known to be empty (because it contains the placeholder). If a value is empty, then it is removed from the extracted data. Thus, the associated key is also removed. In one configuration, data is retrieved by an internal static analysis module that simulates web frameworks and stores the information that needs to be processed to generate information about API endpoints in predefined format.

For example, the data from the extracted source code is received as key/value pairs in step 310, wherein each key/value pair is retrieved in step 312. In step 314, if the value in the retrieved key/value pair begins with the assigned placeholder, the value of the field is known to be empty, and the key/value pair is then removed in step 316. In step 318, the present system checks for more key/value pairs. The next stored key/value pair is examined in the same manner starting at step 312. When there are no more key/value pairs to check, the data extracted by the modified static analysis module returns the data set to the API extractor 100 process at step 120. As another example, the data may be passed from the internal static analysis module as an array of all possible combinations of values that can be applied to a specific part of the endpoint, such as URL, parameter name, identified types of data.

Referring now to FIG. 5, in an exemplary embodiment, the API extractor 100 checks the parent-path for the placeholder, and if there is no placeholder, then the field has a value and the parent-path is not removed. The sub-path is then checked for the placeholder, and if the placeholder is not identified, then the field has a value and the sub-path is not removed. Then, the param-path is checked for the placeholder. In the example, the param-path starts with the assigned placeholder. Thus, the param-type has no value and is removed. In the example, the param-name is then checked for the placeholder. As the param-name begins with the placeholder, there is no value of the field and the param-name is removed.

Thus, the preprocessing can include removing predetermined characters or strings, including assigned predetermined characters or strings from the extracted code. For example, can be removed and then ~~ can be replaced with ““ ””. Any resulting or remaining white spaces in the extracted code can be trimmed. Also, the preprocessing can include modification of extracted source code elements, like string literals to emulate the behavior of language web frameworks and program libraries. The preprocessing can include removing data having no assigned value. In one exemplary configuration, if a variable does not have a value in the report (or extracted code), then the variable is removed.

Thus, the system has extracted some data from the target API source code, and removed the empty values (via the added placeholders). Additional processing is then performed. Generally, each record is separately analyzed and processed, and then added to an index.

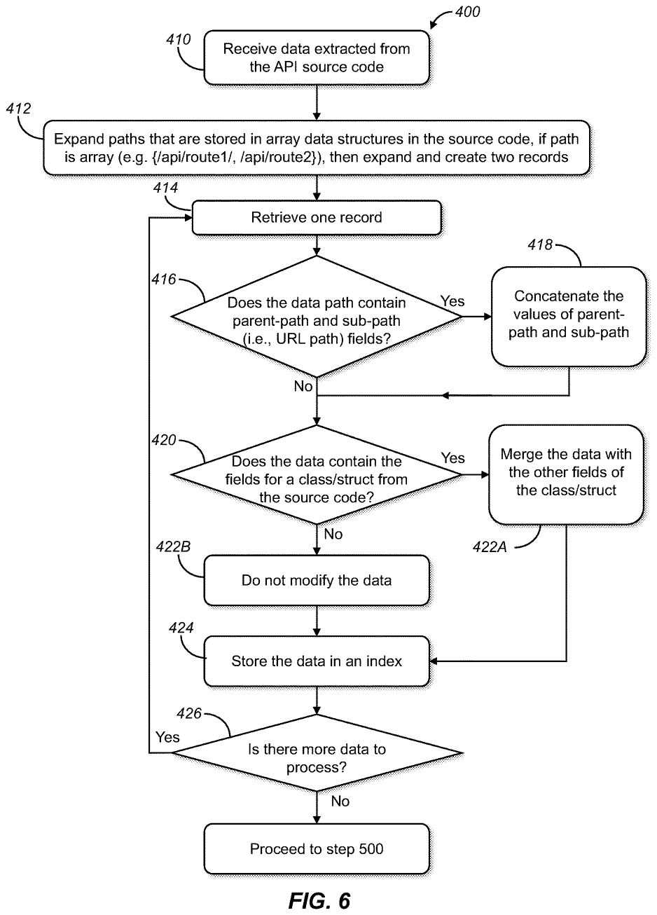

Referring now to FIG. 6, paths that are stored in an array (e.g., {/api/route1/,/api/route2}) are expanded to create two records, one record for each path in step 412. Each record is then retrieved in step 414; and, in step 416, it is determined if the record contains parent-path and sub-path fields. If the record contains parent-path and sub-path fields, then the values of the parent-path and sub-path are concatenated in step 418. That is, the routes that contain parent- and sub-paths are concatenated together. For example, “/api/parent/” and “/subpath/” become “/api/parent/subpath/” and become one record.

The data, concatenated or otherwise, is then analyzed to determine if the data contains fields for a class/struct from the extracted source code in step 420. If the parameter is a field for a class/struct in code, then it is merged with the other fields for that class/struct in step 422A. That is, if there is an extracted class field it is merged with the rest of the fields of the class. Conversely, if the data does not contain the fields for a class/struct from the target source code, then the data is not modified in step 422B. In step 424, the merged or unmerged data is stored to the index. In step 426, the process determines whether there is more data to process; if there is more data to process, the system returns to step 414. When there is no more data to process, the system proceeds to step 500, 600.

It is recognized that some rules (e.g., matching algorithms) may extract two paths, such as the parent path and the child path (i.e., parts of URL paths), as set forth above, these are concatenated to obtain the complete path. The parent path and child path may also be referred to herein as the parent-path and sub-path. In the path concatenation, repetitions of a given character, such as “/” may occur, wherein the repetitions are replaced with a single occurrence.

In one exemplary configuration of the preprocessing in step 400, it is recognized that extracted paths/methods may be in an array. In such case, the array is expanded. The expanded array can result in the generation of identical results for the same path. In one exemplary configuration, if the parameter name is being detected, an index is created where the key is “Result.Path+Result.Method,” then if two results have the same key, the function parameters are merged. It has been found that the function may be across multiple lines, a “result” wide code may not identify the actual occurrences, and thus the results will not reflect the actual target source code. Thus, the code for each parameter is stored. Once the message has been preprocessed, including expanding the paths and merging the function parameters, the captured code is analyzed to identify path parameters, path variables, query parameters, request body and possible request header values.

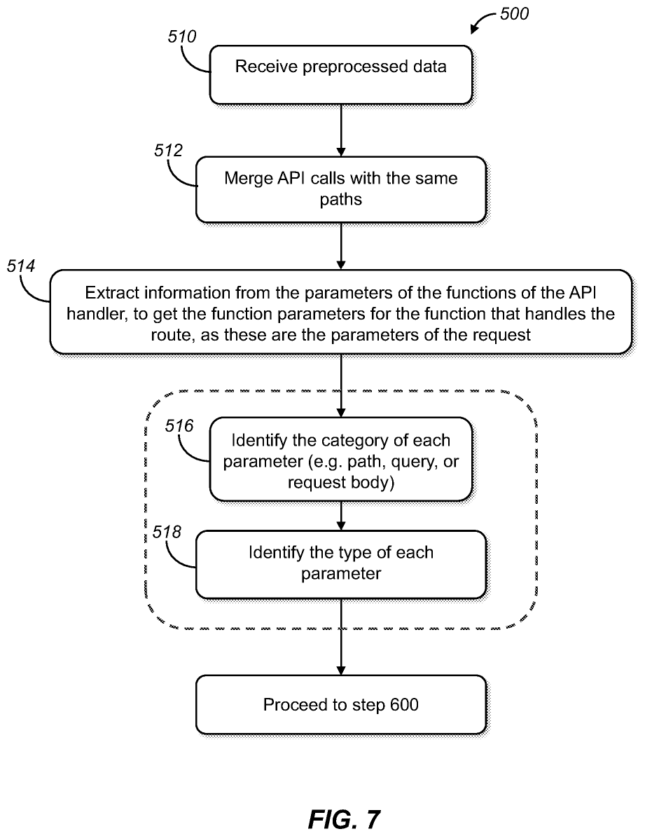

Generally referring to FIG. 7, the processing in step 400 has generated a list, received in step 510, of requests/paths/methods and a list of classes/structs/interfaces and parameters that are associated with them. If a class is associated with a request, then the publicly available fields in the class will appear in the HTTP request that is sent to that API to interact with it. Each field will be one parameter. For example, if the class has two fields then the URL might look like https://example.net?field1=value1&field2=value2.

The objective is to identify which paths are the same but have different methods (e.g., GET or POST) and merge them together, in step 512, because they appear together in the resulting document format that is output by the API extractor 100. Thus, the processed data is received in step 510, and if there are multiple results with the same path having different methods, then these are stored together in step 512. That is, API calls with the same paths are merged. The function parameters for the function that handles the associated route are then taken as the request parameters in step 514. In step 516, the category of each parameter is then identified, such as a path, a query, header or a request body. In step 518, the type of each parameter is identified, such as a string, an integer, or a custom class.

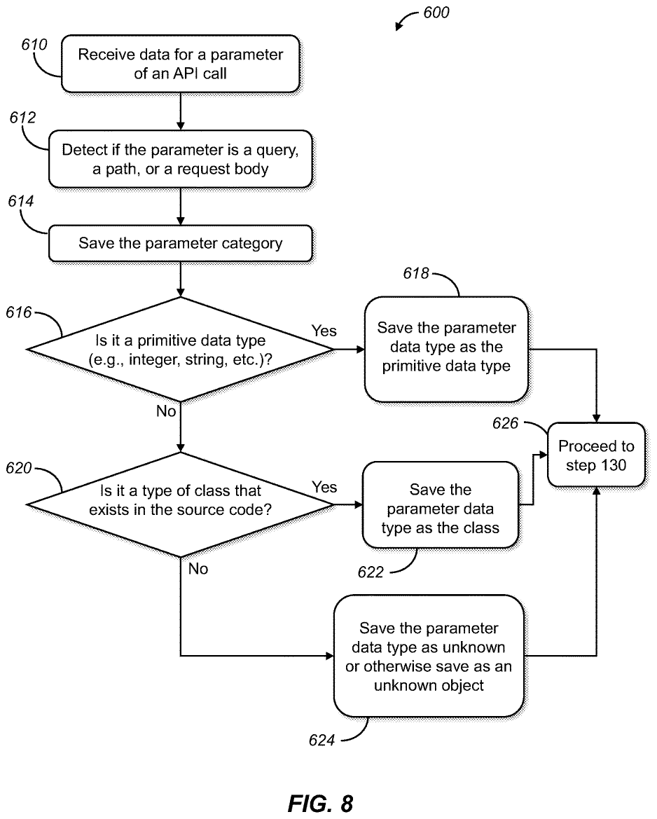

Referring now to FIG. 8, in step 610 the data is received for the parameters of an API call. In determining the category of each parameter in step 612, it is recognized that each parameter can be (i) a path parameter: which appears in the path like https://example.net/user/12/ where 12 is the path parameter; (ii) a query parameter: such as field1 and field2 in the above example https://example.net?field1=value1&field2=value2; or (iii) a RequestBody parameter which appears in the body of the request and it will generally appear as:

/api/route HTTP/1.1
Host: example.net
field1=valuel&field2=value

Once the data is received for the parameters of an API call in step 610, the category of the parameter can be found using annotations and the existence of variables in the route and saved in step 614. Then, as seen in FIG. 8, the type of each parameter is identified, such as a string, an integer, or a custom class in step 616. Identifying the types of each parameter allows for the identification of what kind of values should be put in the request that interacts with the API.

As seen in step 616, each parameter type can be a primitive data type or complex data type. If the parameter type is a primitive data type, the parameter type is saved as the primitive data type in step 618 and the process in step 626 proceeds to step 130. The primitive data type includes but is not limited to integers, floating-point numbers, strings, and Booleans. Specifically, the primitive data type can be a string or an integer. Alternatively, the data type can be a complex type like classes/structs/interfaces, as set forth above. In addition, the complex data type can have one or more fields, wherein each field can be either another complex data type or primitive data type. To accomplish this, the class/struct information is extracted from the source code with the static analysis module and used to identify the parameters, as set forth above, in steps 620 and 622. For example, if a parameter is of type Person and the Person class is identified in the extracted code, it is recognized the parameter three fields of type String for “First name”, “Last name”, and “ID”. If the data type is of a class that does not exist in the source code, the parameter data type is saved as unknown or an unknown object in steps 620 and 622. A request can then be created with these three parameters, as seen in FIG. 8.

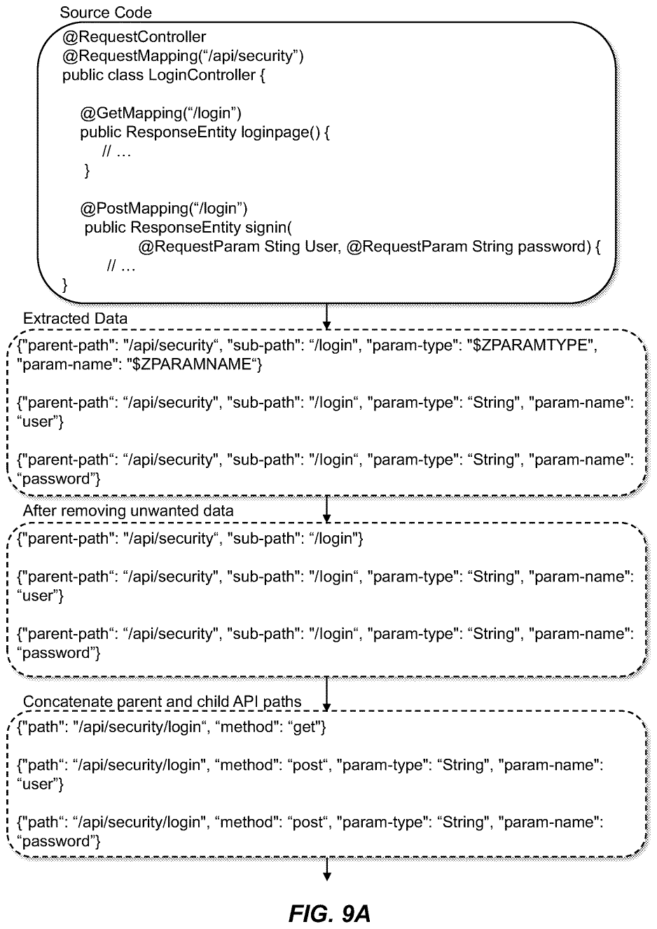

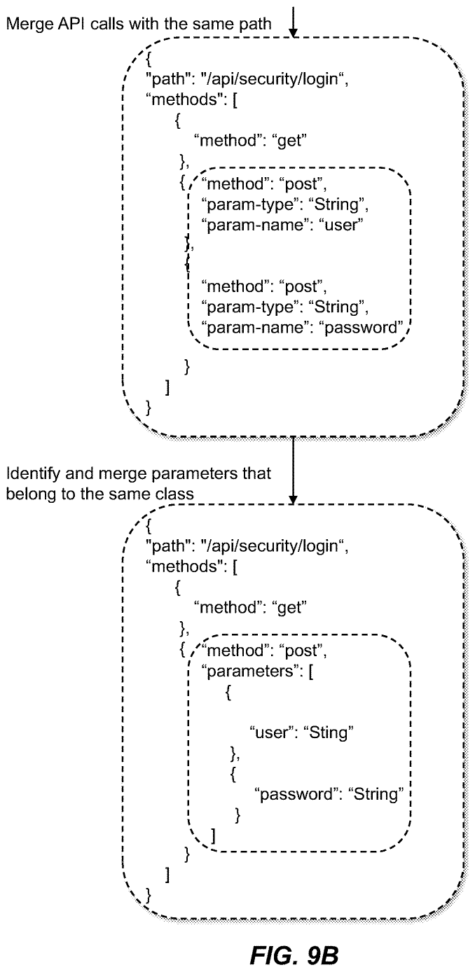

Thus, as seen in FIGS. 9A and 9B, the present system provides for the modified or internal static analysis module with predetermined pattern matching or abstract interpretation of the target source code and generates extracted data, including extracted code. Unwanted, or added foreign separator characters are removed from the extracted data. Parent and child API paths are concatenated and API calls with the same path are merged. With the merged API calls, parameters belonging to the same class are identified and merged. The results are formatted to conform with a predetermined schema.

It is generally contemplated that the results of the API extractor 100 can be employed in a commercially available dynamic analysis tool or dynamic application security testing (DAST) program, such as but not limited to GitLab, Intruder, or StackHawk, as well as others. In particular, by providing the dynamic testing module with otherwise unknown endpoints, the dynamic testing can achieve a greater level of analysis and identification additional vulnerabilities not otherwise locatable by the dynamic testing.

Additional configurations, embodiments, and examples of the presently disclosed subject matter are enumerated below:
Example 1: A method of static analysis of an API source code, the method comprising (a) applying a matching algorithm or a data processor in a static analysis module to the API source code to generate a report having extracted source code from the API source code in a message field, the message field including a plurality of automatically inserted non-operating system specific characters; (b) removing, from the report, extracted values having no assigned value; (c) identifying paths in the extracted source code; (d) concatenating URL paths in the identified paths; (e) expanding arrayed paths to generate a plurality of identical paths corresponding to each arrayed path; (f) detecting a parameter name to generate an index of results and merging parameters having a common key to generate a processed output having merged parameters and expanded paths; (g) identifying a path parameter in the expanded paths corresponding to predetermined characters in the identified paths; (h) assigning a type to each identified path parameter; (i) adding each identified path parameter to the identified path; (j) extracting, in response to a query parameter in the extracted source code having a new name directive, the new name and applying the new name as a query parameter name; (k) identifying a request body parameter in the extracted source code; (l) assigning a type to each identified request body parameter; and (m) assigning the identified request body parameter as a request body parameter name in response to a further predetermined identified directive.
Example 2: The method of Example 1, wherein the matching algorithm and the data processor are configured to identify at least one of a predetermined pattern and a predetermined structure in the API source code.
Example 3: The method of Example 1, further comprising identifying a request body parameter in the extracted source code, assigning a type to each identified request body parameter, and assigning the identified request body parameter as a parameter name in response to a predetermined identified directive.
Example 4: A computer program product comprising one or more non-transitory computer-readable storage device and program instructions stored on at least one of the one or more non-transitory storage devices, the program instructions executable by a processor, the program instructions comprising sets of instructions for: (a) applying a matching algorithm or a data processor to a static analysis module to provide a modified static analysis module, or an internal static analysis module, configured to extract data from the target REST API source code; (b) defining a message field for the modified or internal static analysis module, wherein the message field includes a plurality of added foreign separator characters; (c) applying the modified or internal static analysis module to the target REST API source code to generate a report including the message field and an extracted source code; (d) removing, from the report, extracted values having no assigned value; (e) identifying paths in the extracted source code; (f) concatenating parts of URL paths in the identified paths; (g) expanding arrayed paths to generate a plurality of identical paths corresponding to each arrayed path; (h) detecting a parameter name to generate an index of results and merging parameters having a common key to generate a processed output having merged parameters and expanded paths; (i) identifying a path parameter in the expanded paths corresponding to predetermined characters in the identified paths; (j) assigning one of a plurality of types to each identified path parameter; (k) adding each identified path parameter to the identified path; (l) extracting, in response to a query parameter in the extracted code having a new name directive, the new name and applying the new name as a query parameter name; (m) identifying a request body parameter in the extracted source code; (n) assigning one of a plurality of types to each identified request body parameter; and (o) assigning the identified request body parameter as a request body parameter name in response to a further predetermined identified directive.
Example 5: The computer program product of Example 4, wherein the program instructions further comprise sets of instructions for identifying a request body parameter in the extracted data, assigning a type to each identified request body parameter, and assigning the identified request body parameter as a parameter name in response to a predetermined identified directive.
Example 6: A computing device comprising a set of one or more processing units; and a storage device storing a set of instructions, wherein an execution of the set of instructions by the set of processing units configures the computing device to perform acts comprising: (a) applying a matching algorithm or a data processor to a static analysis module to provide a modified static analysis module, or an internal static analysis module, configured to extract data from the target REST API source code; (b) defining a message field for the modified or internal static analysis module, wherein the message field includes a plurality of added foreign separator characters; (c) applying the modified or internal static analysis module to the target REST API source code to generate a report including the message field and an extracted source code; (d) removing, from the report, extracted values having no assigned value; (e) identifying paths in the extracted source code; (f) concatenating parts of URL paths in the identified paths; (g) expanding arrayed paths to generate a plurality of identical paths corresponding to each arrayed path; (h) detecting a parameter name to generate an index of results and merging parameters having a common key to generate a processed output having merged parameters and expanded paths; (i) identifying a path parameter in the expanded paths corresponding to predetermined characters in the identified paths; (j) assigning one of a plurality of types to each identified path parameter; (k) adding each identified path parameter to the identified path; (l) extracting, in response to a query parameter in the extracted code having a new name directive, the new name and applying the new name as a query parameter name; (m) identifying a request body parameter in the extracted source code; (n) assigning one of a plurality of types to each identified request body parameter; and (o) assigning the identified request body parameter as a request body parameter name in response to a predetermined identified directive.
Example 7: The computing device of Example 6, wherein the computing device is further configured for identifying a request body parameter in the extracted data, assigning a type to each identified request body parameter, and assigning the identified request body parameter as a parameter name in response to a predetermined identified directive.
Example 8: A computer program product comprising one or more non-transitory computer-readable storage device and program instructions stored on at least one of the one or more non-transitory storage devices, the program instructions executable by a processor, the program instructions comprising sets of instructions for: (a) defining output rules and/or data processors for a static analysis module output; (b) applying, by the static analysis module, a static analysis of the target code to generate a report under the output rules, data processors, and captured code; (c) concatenating parts of URL paths to at least partly generate a set of identified paths; (d) expanding arrayed attributes and arrayed identified paths; (e) merging function parameters having a common key; (f) identifying a path parameter corresponding to predetermined characters in at least one path in the set of identified paths; (g) assigning one of a plurality of types to each identified path parameter; (h) adding each identified path parameter to the at least one identified path; (i) detecting, in the captured code, a name change corresponding to at least one predetermined field; (j) identifying a query parameter in the captured code; and (k) assigning the identified query parameter as a query parameter name in response to a predetermined identified directive.
Example 9: The computer program product of Example 8, wherein the program instructions comprise sets of instructions for identifying a request body parameter in the captured code, assigning a type to each identified request body parameter, and assigning the identified request body parameter as a parameter name in response to a predetermined identified directive.
Example 10: A computing device comprising a set of one or more processing units; and a storage device storing a set of instructions, wherein an execution of the set of instructions by the set of processing units configures the computing device to perform acts comprising: (a) defining output rules and data processors for a static analysis module output; (b) applying, by the static analysis module, a static analysis of the target code to generate a report under the output rules, data processors, and captured code; (c) concatenating parts of URL paths to generate at least a portion of a set of identified paths; (d) expanding arrayed attributes and arrayed identified paths; (e) merging function parameters having a common key; (f) identifying a path parameter corresponding to predetermined characters in at least one path in the set of identified paths; (g) assigning one of a plurality of types to each identified path parameter; (h) adding each identified path parameter to the at least one identified path; (i) detecting, in the captured code, a name change corresponding to at least one predetermined field; (j) identifying a query parameter in the captured code; and (k) assigning the identified query parameter as a query parameter name in response to a predetermined identified directive.
Example 11: The computing device of Example 10, wherein the execution of the set of instructions by the set of processing units further configures the computing device to perform acts comprising identifying a request body parameter in the captured code, assigning a type to each identified request body parameter, and assigning the identified request body parameter as a parameter name in response to a predetermined identified directive.
Example 12: A computer program product comprising one or more non-transitory computer-readable storage device and program instructions stored on at least one of the one or more non-transitory storage devices, the program instructions executable by a processor, the program instructions comprising sets of instructions for: (a) extracting, with a static analysis module pursuant to a matching algorithm or data processor, data target API code, the data including captured data and variables through a predefined message field; (b) processing the captured data to a predetermined format; (c) preprocessing the captured data in the predetermined format to identify path parameters; (d) comparing identified path parameters with captured path parameters to identify a parameter type; (e) identifying a name change from a located identifier in the captured code; (f) extracting, in response to a query parameter in the captured code having a new name directive, a new name and using the new name as a query parameter name; and (g) employing the identified paths in a dynamic application security testing (DAST) module.
Example 13: The computer program product of Example 12, wherein the program instructions further comprise instructions for identifying a request body parameter in the captured data, assigning a type to each identified request body parameter, and assigning the identified request body parameter as a parameter name in response to a predetermined identified directive.
Example 14: A computing device, comprising a set of one or more processing units; and a storage device storing a set of instructions, wherein an execution of the set of instructions by the set of processing units configures the computing device to perform acts comprising: (a) extracting, with a static analysis module pursuant to a matching algorithm or data processor, data target API code, the data including captured data and variables through a predefined message field; (b) processing the captured data to a predetermined format; (c) preprocessing the captured data in the predetermined format to identify path parameters; (d) comparing identified path parameters with captured path parameters to identify a parameter type; (e) identifying a name change from a located identifier in the captured code; (f) extracting, in response to a query parameter in the captured code having a new name directive, a new name and using the new name as a query parameter name; and (g) employing the identified paths in a dynamic application security testing (DAST) module.
Example 15: The computing device of Example 14, wherein the execution of the set of instructions by the set of processing units further configures the computing device to perform acts comprising identifying a request body parameter in the captured code, assigning a type to each identified request body parameter, and assigning the identified request body parameter as a parameter name in response to a predetermined identified directive.

The drawings schematically depict one more example processes in the form of a flowchart. It should be understood that operations that are not depicted can be incorporated into the example methods and processes that are schematically illustrated. For example, one or more additional operations can be performed before, after, simultaneously, or between any of the illustrated operations. Additionally, the operations may be rearranged or reordered in other implementations. In one or more exemplary configurations, operations are parallel processed. The separation of various operations in the configurations described herein should not be understood as requiring such separation in all configurations, and it should be understood that the described processes and systems can generally be integrated together in a single software product or packaged into multiple software products.

While various embodiments of the present disclosure are described in detail herein, it should be understood that they are presented by way of example, and not limitation. It will be apparent to persons skilled in the relevant arts that the disclosed subject matter may be embodied in other specific forms, variations, and modifications without departing from the scope, spirit, or essential characteristics thereof. One or more features of the embodiments described herein may be combined to create additional embodiments which are not depicted. The embodiments described herein are therefore to be considered in all respects as illustrative, and not restrictive. The scope of the invention is indicated by the appended claims, and all changes that come within the meaning and range of equivalents thereof are intended to be embraced therein.

What is claimed is:

1. A method of generating an application program interface (API) specification for a target representational state transfer (REST) API source code, the method comprising:
(a) applying a matching algorithm to a static analysis module to provide a modified static analysis module, or applying one or more data processors to an internal static analysis module, configured to extract data from the target REST API source code;
(b) defining a message field for the modified static analysis module or the internal static analysis module, wherein the message field includes a plurality of added foreign separator characters or predefined separator symbols;
(c) applying the modified static analysis module or the internal static analysis module to the target REST API source code to generate a report including the message field and an extracted source code;
(d) removing, from the report, extracted values having no assigned value;
(e) identifying paths in the extracted source code;
(f) concatenating at least a subset of the identified uniform resource locator (URL) paths;
(g) expanding arrayed paths to generate a plurality of identical paths corresponding to each arrayed path;
(h) detecting a parameter name to generate an index of results and merging parameters having a common key to generate a processed output having merged parameters and expanded paths;
(i) identifying a path parameter in the expanded paths corresponding to predetermined characters in the identified paths;
(j) assigning one of a plurality of types to each identified path parameter;
(k) adding each identified path parameter to the identified path;
(l) extracting, in response to a query parameter in the extracted code having a new name directive, the new name and applying the new name as a query parameter name;
(m) identifying a request body parameter in the extracted source code;
(n) assigning one of a plurality of types to each identified request body parameter; and
(o) assigning the identified request body parameter as a request body parameter name in response to a predetermined identified directive.

2. The method of claim 1, further comprising replacing and trimming portions of the extracted source code and converting the extracted source code to a predetermined file format.

3. The method of claim 1, further comprising identifying a file format corresponding to a predetermined field in the extracted source code.

4. The method of the claim 1, further comprising employing the extracted source code in a dynamic application security testing (DAST) module.

5. The method of the claim 1, wherein the static analysis module is a static application security testing (SAST) module.

6. The method of the claim 1, wherein the extracted values are metavariables, and wherein the extracted values that have no assigned value are removed via one or more decision trees or data processors.

7. The method of the claim 1, wherein the matching algorithm or data processor comprises a code analysis rule identifying at least one of a predetermined pattern and a predetermined structure in the target API source code.

8. The method of the claim 1, further comprising identifying a request body parameter in the captured code, assigning the identified request body parameter as a request parameter name in response to a predetermined identified directive, and detecting, in the captured code, a name change corresponding to at least one predetermined field.

9. A method of identifying paths in a target code, the method comprising:
(a) defining output rules for a static analysis module output;
(b) applying, by the static analysis module, a static analysis of the target code to generate a report under the output rules and captured code;
(c) concatenating combinations of uniform resource locator (URL) paths to generate a set of identified paths;
(d) expanding arrayed attributes and arrayed identified paths;
(e) merging function parameters having a common key;
(f) identifying a path parameter corresponding to predetermined characters in at least one path in the set of identified paths;
(g) assigning one of a plurality of types to each identified path parameter;
(h) adding each identified path parameter to the at least one identified path;
(i) detecting, in the captured code, a name change corresponding to at least one predetermined field;
(j) identifying a query parameter in the captured code; and
(k) assigning the identified query parameter as a query parameter name in response to a predetermined identified directive.

10. The method of claim 9, further comprising identifying a file format corresponding to predetermined field in the captured code.

11. The method of the claim 9, further comprising employing at least one identified path having the added path parameter in a dynamic application security testing (DAST) module.

12. The method of the claim 9, further comprising identifying a request body parameter in the captured code, assigning a type to each identified request body parameter, and assigning the identified request body parameter as a parameter name in response to a predetermined identified directive.

13. The method of the claim 9, wherein the static analysis module is a static application security testing (SAST) module.

14. The method of the claim 9, wherein the output rules include a matching algorithm or data processor.

15. The method of the claim 9, further comprising performing, at a subsequent time, steps (b) through (k) to the target code and comparing parameter names between the first iteration and the second iteration.

16. The method of the claim 9, further comprising identifying a request body parameter in the captured code; assigning the identified request body parameter as a request parameter name in response to a predetermined identified directive; detecting, in the captured code, a name change corresponding to at least one predetermined field.

17. A method of detecting hidden and undocumented paths in a target application program interface (API) code, the method comprising:
(a) extracting, with a static analysis module configured via a matching algorithm or a data processor, data from the target API code, the data including captured data and variables through a predefined message field;
(b) processing the captured data to a predetermined format;
(c) preprocessing the captured data in the predetermined format to identify path parameters;
(d) comparing identified path parameters with captured path parameters to identify a parameter type;
(e) identifying a name change from a located identifier in the captured code;
(f) extracting, in response to a query parameter in the captured code having a new name directive, a new name and using the new name as a query parameter name; and
(g) employing the identified paths in a dynamic application security testing (DAST) module.

18. The method of claim 17, further comprising setting a media type in response to predetermined label in the captured code.

19. The method of claim 17, wherein processing the captured data to a predetermined format includes at least one of (i) removing predetermined characters; (ii) replacing unique added separators; and (iii) trimming white spaces.

20. The method of claim 17, wherein preprocessing the captured data includes at least one of (i) removing predetermined keys and associated values; (ii) concatenating paths corresponding to a given separator; (iii) expanding arrayed paths; (iv) indexing parameter names; and (v) merging identical keys in different results to merge function parameters and expanded paths.

21. The method of the claim 17, further comprising, prior to employing the identified paths in the dynamic application security testing DAST module, identifying a request body parameter in the captured code; assigning a type to each identified request body parameter; and assigning the identified request body parameter as a parameter name in response to a further predetermined identified directive.

22. The method of the claim 17, wherein the static analysis module is a static application security testing (SAST) module.

23. The method of the claim 17, wherein the extracted variables are metavariables.

24. The method of the claim 17, further comprising identifying a request body parameter in the captured data, assigning a type to each identified request body parameter, and assigning the identified request body parameter as a parameter name in response to a predetermined identified directive.
